(19) United States
(12) Patent Application Publication
(10) Pub. No.: US 2022/0079262 A1
(43) Pub. Date: Mar. 17, 2022

(54) MASK WITH ADJUSTABLE EAR LOOPS AND MANUFACTURING METHOD THEREOF

(71) Applicant: YUNG-TENG HSU, Hsinchu County (TW)

(72) Inventor: YUNG-TENG HSU, Hsinchu County (TW)

(73) Assignee: POLESTAR DEVELOPING TRADING CO., LTD., Hsinchu County (TW)

(21) Appl. No.: 17/472,501

(22) Filed: Sep. 10, 2021

(30) Foreign Application Priority Data
Sep. 17, 2020 (TW) 109132121

(51) Int. Cl. A41D 13/11

(52) U.S. Cl. CPC A41D 13/1115; A41D 2500/30; A41D 13/1169

(57) ABSTRACT

A mask with adjustable ear loops comprises a body and a pair of ear loops. The ear loops are respectively disposed on two lateral sides of the body. Each of the ear loops is elastic and has an elongated and flat shape, each of the ear loops has two ends and an ear attaching portion between the two ends, and each of the ear loops is disposed on one of the lateral sides of the body through the two ends respectively. The ear attaching portion has a first length and a first temporary adhesive area, the first temporary adhesive area makes the ear attaching portion adhere to the lateral side of the body so that the ear attaching portion has a second length, and the second length is less than the first length.

### BACKGROUND OF THE INVENTION

### Field of Invention

The invention relates to a mask, and more particularly to a mask with adjustable ear loops and a manufacturing method thereof, and a user is capable of conveniently adjusting and feeling comfortable when wearing the mask.

### Related Art

In view of the living environment being polluted by various sources of pollution in the air, and for preventing the spread of diseases, mask is not just a medical supply, it has become a necessity for the general public. Generally, the main layers of medical mask are made of cloth or paper, and ear cords for hanging on the ears are added on two sides of the main part of the mask to facilitate wearing and taking off the mask by the user.

However, most masks commonly sold on the market currently use elastic materials for making the ear cords. Based on the materials used and configuration of the fixed length and width of the ear cords, the mask may not fit the face shapes of different users and become too loose or too tight when being worn, and cause the users to even feel uncomfortable. In addition, when manufacturers make the masks, the ear cords need to be additionally processed to be put on the mask body, which increases the production time of the overall production line.

### SUMMARY OF THE INVENTION

A mask with adjustable ear loops and a manufacturing method thereof disclosed in the invention are capable of solving the aforementioned drawbacks and problems.

One embodiment of the invention provides a mask with adjustable ear loops comprising a body and a pair of ear loops. The body defines a space for accommodating and covering the mouth and nose of a user, wherein the body has an upper side, a lower side opposite to the upper side, and two lateral sides with a spacing relatively longer than a spacing between the upper side and the lower side. The pair of ear loops are respectively disposed on the two lateral sides of the body. Each of the ear loops is elastic and has an elongated and flat shape, each of the ear loops has two ends and an ear attaching portion between the two ends, and each of the ear loops is disposed on one of the lateral sides of the body through the two ends respectively. Particularly, the ear attaching portion has a first length and a first temporary adhesive area, the first temporary adhesive area makes the ear attaching portion adhere to the lateral side of the body so that the ear attaching portion has a second length, and the second length is less than the first length. Therefore, when the mask of the invention is worn by different users, the users are capable of adjusting a length of each of the ear loops according to the face shape.

In one embodiment, the ear attaching portion is adhered to the lateral side of the body, when the mask is being stored away, the ear attaching portion is folded and has a scaly shape, and has at least one W-corrugated shape when being halfway-unfolded, and a length of the folded ear attaching portion is the same as a length of the lateral side.

In one embodiment, the ear attaching portion has a second temporary adhesive area different from the first temporary adhesive area, the second temporary adhesive area makes the ear attaching portion adhere to the lateral side of the body so that the ear attaching portion has a third length, and the third length is less than the second length.

In one embodiment, a bendable pad is provided on the upper side of the body.

In one embodiment, the body is at least one layer of non-woven fabric, and the ear loop is a non-woven fabric with high elasticity.

Another embodiment of the invention provides a manufacturing method of a mask with adjustable ear loops comprising steps of: a conveying unit providing an elastic non-woven fabric and a mask body, causing the elastic non-woven fabric and the mask body to travel at the same time; folding the elastic non-woven fabric by a folding unit into a W shape and conveying the elastic non-woven fabric to a cutting knife module; the cutting knife module cutting off the elastic non-woven fabric folded into a W shape to form an ear loop with a fixed width, wherein the ear loop has two ends and an ear attaching portion between the two ends, and the ear attaching portion has a first length; the conveying unit sending the ear loop to dispose between a fusing module and the mask body, the traveling mask body and the fusing module together driving the ear loop to move forward; and the fusing module fusing the two ends of the ear loop with upper and lower sides of the mask body respectively, at the same time fusing a portion of the ear attaching portion of the ear loop with one lateral side of the mask body to form a first temporary adhesive area, causing the ear attaching portion having a second length, and the second length being less than the first length.

In one embodiment, further comprising: the conveying unit conveying the mask body and the ear loop fused on the mask body to a cutting roller, and the cutting roller cutting at a dividing line at a center of the fixed width of the ear loop to form a mask.

In one embodiment, a width of the elastic non-woven fabric folded into a W shape is substantially equal to a width of the mask body.

In one embodiment, the fixed width of the ear loop can be adjusted according to sales requirements.

In one embodiment, when the fusing module fusing the two ends of the ear loop with the upper and lower sides of the mask body, comprising: fusing another portion of the ear attaching portion of the ear loop with the lateral side of the mask body at the same time to form a second temporary adhesive area, causing the ear attaching portion having a third length, and the third length being less than the second length.

### BRIEF DESCRIPTION OF THE DRAWINGS

FIG. 1A and FIG. 1B are respectively perspective front and back views of a mask with adjustable ear loops in one embodiment of the invention;

FIG. 2A and FIG. 2B are respectively a back plan view of the mask with the adjustable ear loops and a perspective view of the ear loops being fully unfolded in one embodiment of the invention;

FIG. 3 is a perspective view of the ear loops of the mask in FIG. 2A being partially unfolded;

FIG. 4 is a flowchart of a manufacturing method of a mask with adjustable ear loops in one embodiment of the invention; and

FIG. 5 is a plan view of a portion of a process production line of the manufacturing method of the mask with the adjustable ear loops in one embodiment of the invention.

### DETAILED DESCRIPTION OF THE INVENTION

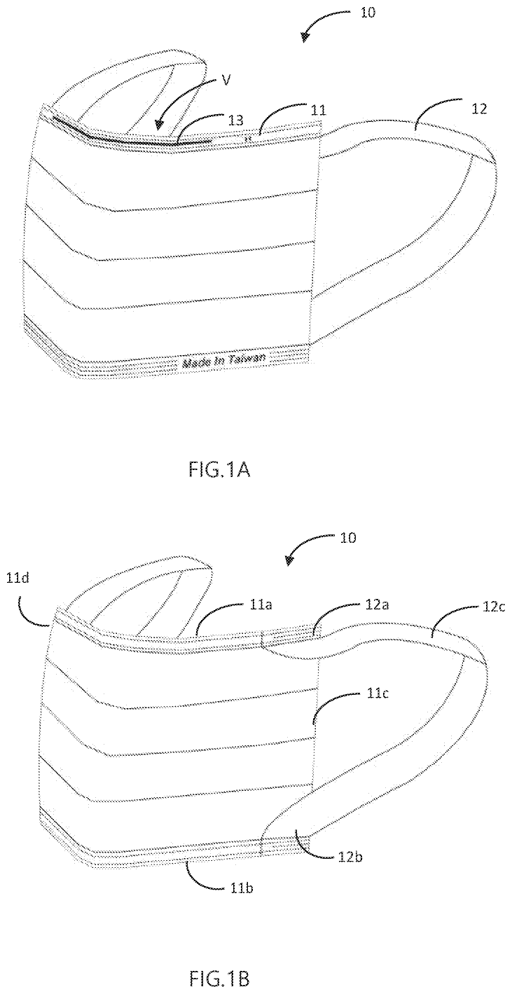

Please refer to FIGS. 1A and 1B respectively for perspective front and back views of a mask 10 with adjustable ear loops in one embodiment of the invention. The mask 10 comprises a body 11 and a pair of ear loops 12. The body 11 defines a space V for accommodating and covering the mouth and nose of a user. Wherein the body 11 has an upper side 11a, a lower side 11b opposite to the upper side 11a, and two lateral sides 11c, 11d with a spacing relatively longer than a spacing between the upper side 11a and the lower side 11b. The pair of ear loops 12 are respectively disposed on the two lateral sides 11c, 11d of the body 11. Each of the ear loops 12 is elastic and has an elongated and flat shape, each of the ear loops 12 has two ends 12a, 12b and an ear attaching portion 12c between the two ends 12a, 12b, and each of the ear loops 12 is disposed on one of the lateral sides 11c, 11d of the body 11 through the two ends 12a, 12b respectively.

In one embodiment, a bendable pad 13 is provided on the upper side 11a of the body 11.

In one embodiment, the body 11 is at least one layer of non-woven fabric, and the ear loop 12 is a non-woven fabric with high elasticity.

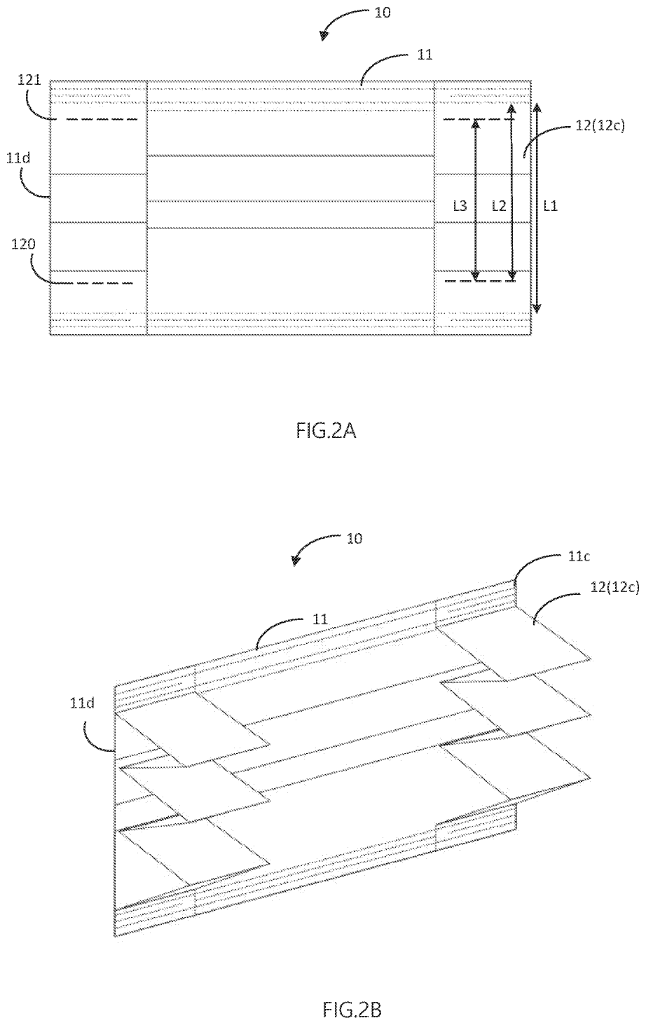

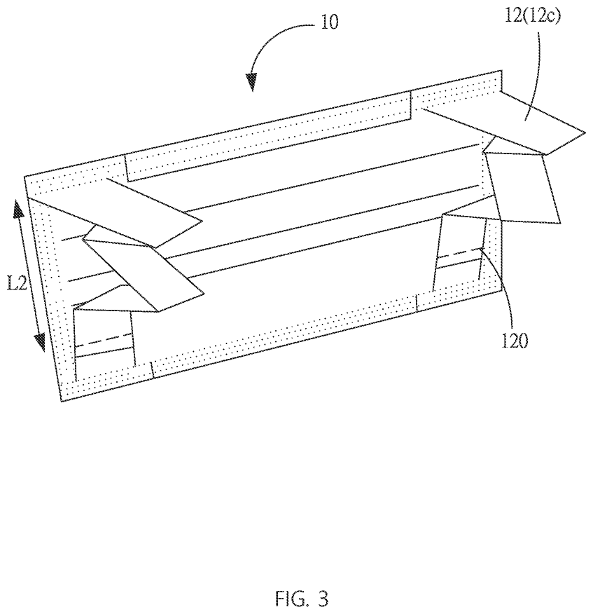

Please refer to FIGS. 2A to 2B, and FIG. 3 respectively for a back plan view of the mask 10 with the adjustable ear loops 12, a perspective view of the ear loops 12 being fully unfolded, and a perspective view of the ear loops 12 being partially unfolded in one embodiment of the invention.

Particularly, the ear attaching portion 12c has a first length L1 and a first temporary adhesive area 120, the first temporary adhesive area 120 makes the attaching ear portion 12c adhere to the lateral side 11c or 11d of the body 11 so that the ear attaching portion 12c has a second length L2, and the second length L2 is less than the first length L1. Therefore, when the mask 10 of the invention is worn by different users, the users can decide whether to tear the attaching ear portion 12c off from the first temporary adhesive area 120 according to the face shape in order to adjust a length of each of the ear loops 12.

Corresponding to the perspective view of the ear loops 12 of FIG. 2B being unfolded to form at least one W shape; the ear attaching portion 12c is adhered to the lateral side 11c or 11d of the body 11, when the mask 10 is being stored away, the ear attaching portion 12c is folded and has a scaly shape, and has at least one W-corrugated shape when being halfway-unfolded, and a length of the folded ear attaching portion 12c is the same as a length of the lateral side 11c or 11d. The W-shaped folding portion of the ear loop 12 can be unfolded according to a distance between the user's ear and cheek, and the user can decide whether to tear the attaching ear portion 12c off from the first temporary adhesive area 120 in order to determine the first length L1 or the second length L2 of the ear attaching portion 12c, and adjust according to the user's face shape. For example, females usually have faces smaller than that of males, as shown in FIG. 3, the attaching ear portion 12c is not torn off from the first temporary adhesive area 120, so that the ear attaching portion 12c maintains the second length L2.

In one preferred embodiment, referring to FIG. 2A again, the ear attaching portion 12c has a second temporary adhesive area 121 that is different from the first temporary adhesive area 120, the second temporary adhesive area 121 makes the ear attaching portion 12c adhere to the lateral side 11c or 11d of the body 11 so that the ear attaching portion 12c has a third length L3, and the third length L3 is less than the second length L2. For example, children usually have faces much smaller than that of adults, the attaching ear portion 12c is not torn off from the first temporary adhesive area 120 and the second temporary adhesive area 121, so that the ear attaching portion 12c maintains the third length L3, which is convenient for children to wear the mask 10 without loosening.

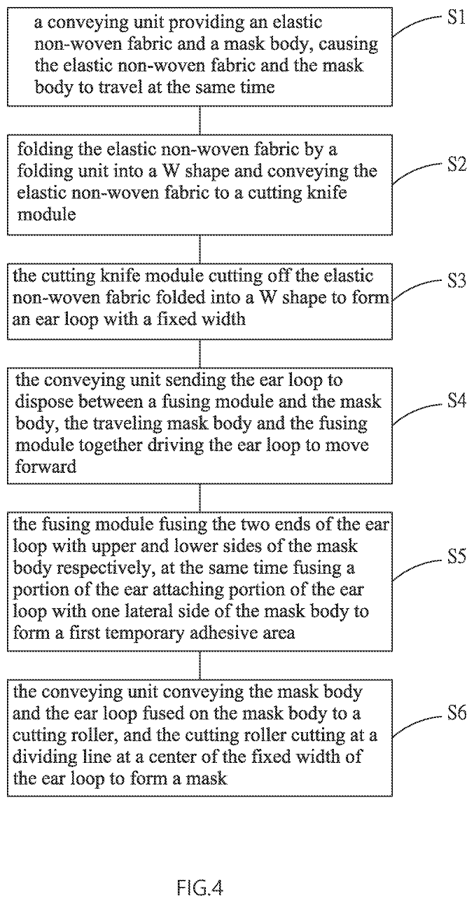

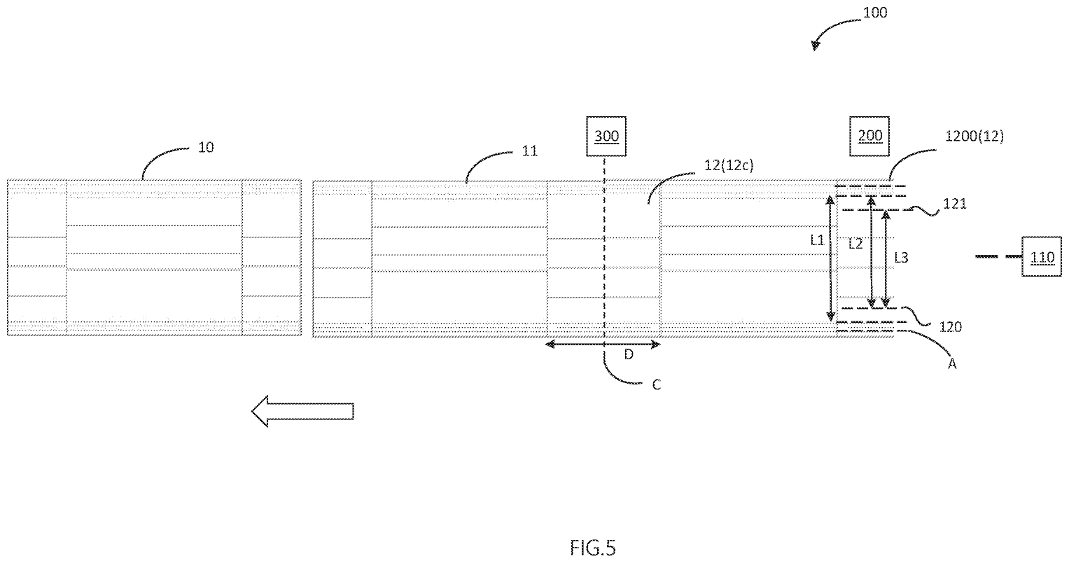

Please refer to FIG. 4 in conjunction with FIG. 5, which are respectively a flowchart and a plan view of a portion of a process production line 100 of a manufacturing method of a mask with adjustable ear loops in another embodiment of the invention. The manufacturing method at least comprises the following steps S1-S5.

Step S1: a conveying unit 110 providing an elastic non-woven fabric 1200 and a mask body 11, causing the elastic non-woven fabric 1200 and the mask body 11 to travel along an arrow direction in FIG. 5 at the same time;

step S2: folding the elastic non-woven fabric 1200 by a folding unit into a W shape and conveying the elastic non-woven fabric 1200 to a cutting knife module;

step S3: the cutting knife module cutting off the elastic non-woven fabric 1200 folded into a W shape to form an ear loop 12 with a fixed width D; in one embodiment, the fixed width D of the ear loop 12 can be adjusted according to sales requirements; wherein the ear loop 12 has two ends and an ear attaching portion 12c between the two ends, and the ear attaching portion 12c has a first length L1; in one embodiment, as shown in FIG. 5, a long side of the elastic non-woven fabric 12 folded into a W shape is substantially equal to a short side of the mask body 11;

step S4: the conveying unit 110 sending the ear loop 12 to dispose between a fusing module 200 and the mask body 11, the traveling mask body 11 and the fusing module 200 together driving the ear loop 12 to move forward;

step S5: the fusing module 200 fusing the two ends of the ear loop 12 with upper and lower sides of the mask body 11 respectively to form several fusing lines A; at the same time fusing a portion of the ear attaching portion 120c of the ear loop 12 with one lateral side of the mask body 11 to form a first temporary adhesive area 120, causing the ear attaching portion 120c having a second length L2, and the second length L2 being less than the first length L1; wherein, fusing methods include thermal bonding, hot pressing roller bonding, ultrasonic bonding, glue bonding, or high-frequency bonding;

in one embodiment, the step S5 further comprising: fusing another portion of the ear attaching portion 12c of the ear loop 12 with the lateral side of the mask body 11 at the same time to form a second temporary adhesive area 121, causing the ear attaching portion 12c having a third length L3, and the third length L3 being less than the second length L2; and step S6: the conveying unit 110 conveying the mask body 11 and the ear loop 12 fused on the mask body 11 to a cutting roller 300, and the cutting roller 300 cutting at a dividing line C at a center of the fixed width D of the ear loop 12 to form a mask 10.

In the mask with the adjustable ear loops and the manufacturing method thereof provided by the embodiments of the invention, the W-shaped folding portion of the ear loop can be unfolded according to a distance between the user's ear and the cheek, and the user can decide whether to tear the attaching ear portions off from the temporary adhesive areas in order to determine the length of the ear attaching portions, and adjust according to the user's face shape, so that different users are able to feel comfortable when wearing the mask, without the discomfort of being loosen or too tight. In addition, the manufacturing method does not require additional production lines to process the ear cords on the mask body when making the mask, which greatly reduces the production time of the overall production line.

The basic principles, main features and advantages of the invention have been shown and described above. Those skilled in the art should understand that the invention is not limited by the above-mentioned embodiments. Descriptions in the above-mentioned embodiments and specification merely illustrate the principles of the invention, without departing from the spirit and scope of the invention, the invention will have various changes and improvements, all these changes and improvements shall fall within the scope of protection of the invention, and the scope of protection of the invention is defined by the appended claims and their equivalents.

What is claimed is:

1. A mask with adjustable ear loops comprising:
a body defining a space for accommodating and covering the mouth and nose of a user, wherein the body has an upper side, a lower side opposite to the upper side, and two lateral sides with a spacing relatively longer than a spacing between the upper side and the lower side; and
a pair of ear loops respectively disposed on the two lateral sides of the body, each of the ear loops being elastic and having an elongated and flat shape, each of the ear loops having two ends and an ear attaching portion between the two ends, each of the ear loops being disposed on one of the lateral sides of the body through the two ends respectively, wherein the ear attaching portion has a first length and a first temporary adhesive area, the first temporary adhesive area makes the ear attaching portion adhere to the lateral side of the body so that the ear attaching portion has a second length, and the second length is less than the first length.

2. The mask with the adjustable ear loops as claimed in claim 1, wherein the ear attaching portion is adhered to the lateral side of the body, when the mask is being stored away, the ear attaching portion is folded and has a scaly shape, and has at least one W-corrugated shape when being halfway-unfolded, and a length of the folded ear attaching portion is the same as a length of the lateral side.

3. The mask with the adjustable ear loops as claimed in claim 1, wherein the ear attaching portion has a second temporary adhesive area different from the first temporary adhesive area, the second temporary adhesive area makes the ear attaching portion adhere to the lateral side of the body so that the ear attaching portion has a third length, and the third length is less than the second length.

4. The mask with the adjustable ear loops as claimed in claim 1, wherein a bendable pad is provided on the upper side of the body.

5. The mask with the adjustable ear loops as claimed in claim 1, wherein the body is at least one layer of non-woven fabric, and the ear loop is a non-woven fabric with high elasticity.

6. A manufacturing method of a mask with adjustable ear loops comprising steps of:
a conveying unit providing an elastic non-woven fabric and a mask body, causing the elastic non-woven fabric and the mask body to travel simultaneously;
folding the elastic non-woven fabric by a folding unit into a W shape and conveying the elastic non-woven fabric to a cutting knife module;
the cutting knife module cutting off the elastic non-woven fabric folded into a W shape to form an ear loop with a fixed width, wherein the ear loop has two ends and an ear attaching portion between the two ends, and the ear attaching portion has a first length;
the conveying unit sending the ear loop to dispose between a fusing module and the mask body, the traveling mask body and the fusing module together driving the ear loop to move forward; and
the fusing module fusing the two ends of the ear loop with upper and lower sides of the mask body respectively, at the same time fusing a portion of the ear attaching portion of the ear loop with one lateral side of the mask body to form a first temporary adhesive area, causing the ear attaching portion having a second length, and the second length being less than the first length.

7. The manufacturing method as claimed in claim 6, further comprising: the conveying unit conveying the mask body and the ear loop fused on the mask body to a cutting roller, and the cutting roller cutting at a dividing line at a center of the fixed width of the ear loop to form a mask.

8. The manufacturing method as claimed in claim 6, wherein a long side of the elastic non-woven fabric folded into a W shape is substantially equal to a short side of the mask body.

9. The manufacturing method as claimed in claim 6, wherein the fixed width of the ear loop can be adjusted according to requirements.

10. The manufacturing method as claimed in claim 6, wherein when the fusing module fuses the two ends of the ear loop with the upper and lower sides of the mask body, another portion of the ear attaching portion of the ear loop is fused with the lateral side of the mask body at the same time to form a second temporary adhesive area and cause the ear attaching portion to have a third length, and the third length is less than the second length.
